(19) United States
(12) Patent Application Publication
(10) Pub. No.: US 2019/0224946 A1
(43) Pub. Date: Jul. 25, 2019

(54) PROTECTIVE STICKER SHEET AND METHOD OF PASTING PROTECTIVE STICKER SHEET

(71) Applicants: Interface Technology (ChengDu) Co., Ltd., Sichuan (CN); Interface Optoelectronics (ShenZhen) Co., Ltd., Guangdong (CN); General Interface Solution Limited, Miaoli County (TW)

(72) Inventors: Jia-Sin HUANG, Guangdong (CN); Hung-Chien LEE, Guangdong (CN); Yen-Chang YAO, Guangdong (CN); Yen-Heng HUANG, Guangdong (CN)

(21) Appl. No.: 15/912,586

(22) Filed: Mar. 6, 2018

(30) Foreign Application Priority Data
Jan. 22, 2018 (CN) 201810058816.8

(51) Int. Cl. B32B 7/12; B32B 27/08; B32B 27/40; B32B 27/30; B32B 27/36; B32B 27/28; B32B 27/32; C09J 7/30

(52) U.S. Cl. CPC B32B 7/12; C09J 7/243; B32B 27/40; B32B 27/308; B32B 27/36; B32B 27/286; B32B 27/32; C09J 7/30; B32B 2405/00; B32B 2250/03; B32B 2307/412; B32B 2307/584; B32B 2367/00; B32B 2371/00; B32B 27/08

(57) ABSTRACT

A protective sticker sheet includes a protective film, an adhesive layer disposed on the protective film, and a release film disposed on the adhesive layer. The release film has a cutting line, and the cutting line defines a reserved portion and a detachable removal portion. The removal portion surrounds at least a portion of the reserved portion.

### CROSS-REFERENCE TO RELATED APPLICATION

This application claims priority to Chinese Application Serial Number 201810058816.8, filed Jan. 22, 2018, which is herein incorporated by reference.

### BACKGROUND

### Field of Invention

The present invention relates to a protective sticker sheet and a method of pasting a protective sticker sheet.

### Description of Related Art

Current handheld electronic devices such as smartphones or tablets conventionally have a larger screen and a more elaborate design. A protective film is usually adhered on the surface of the portion to be protected (such as a screen) of the handheld electronic devices to prevent being damaged or scratched when in collision with other objects. An adhesive layer is disposed on a surface of the protective film, which is made of transparent material, to bond the protective film with the handheld electronic device. A release film is disposed on the adhesive layer to prevent any contaminant (such as dust particles). In general, the release film is integrally formed and has a contour in the same with that of the protective film. When in use, the release film is detached from the protective film to be adhered to expose the adhesive layer.

However, a portion of the adhesive layer commonly remains on the surface of the portion to be protected, which is due to the lasting adhesion between the protective film and the surface of the portion to be protected. Therefore, portions of the adhesive layer may remain on the surface of the portion to be protected even the protective film is detached. Similarly, the same issue described above may occur if an electronic device having the protective film is put under high ambient temperature.

Accordingly, the conventional approaches are inconvenient and adverse, and need to be improved. Hence, there is an urgent call for addressing the foregoing issue.

### SUMMARY

One aspect of the present invention is to provide a protective sticker sheet. The protective sticker sheet includes a protective film, an adhesive layer disposed on the protective film, and a release film disposed on the adhesive layer. The release film has a cutting line, and the cutting line defines a reserved portion and a detachable removal portion. The removal portion surrounds at least a portion of the reserved portion.

In some embodiments of the present invention, the removal portion surrounds at least three-quarters of a periphery of the reserved portion.

In some embodiments of the present invention, the removal portion has an outer contour line and an inner contour line, and the outer contour line and the inner contour line has a distance greater than 2 mm in between.

In some embodiments of the present invention, the protective film includes polyester resins, polysulfone resins, polyetherketone resins or polyolefin resins.

In some embodiments of the present invention, the release film includes polyester resins, polysulfone resins, polyetherketone resins or polyolefin resins.

In some embodiments of the present invention, the adhesive layer includes acrylic, polyurethane or silicone.

In some embodiments of the present invention, the protective film has a thickness of 25-75 micrometers.

In some embodiments of the present invention, the release film has a thickness of 25-75 micrometers.

In some embodiments of the present invention, the adhesive layer has a thickness of 5-25 micrometers.

Another aspect of the present invention is to provide a method of pasting a protective sticker sheet. The method includes: (a) providing a workpiece, the workpiece has a portion to be protected; (b) providing a protective sticker sheet, the protective sticker sheet has a protective film, an adhesive layer disposed on the protective film, and a release film disposed on the adhesive layer. The release film has a cutting line, the cutting line defines a reserved portion and a detachable removal portion, and the removal portion surrounds at least a portion of the reserved portion; (c) removing the removal portion of the protective sticker sheet to form an adherable protective sticker, in which the reserved portion remains on the adhesive layer, and a portion of the adhesive layer is exposed; and (d) adhering the adherable protective sticker on the portion to be protected of the workpiece, in which the reserved portion is located between the adhesive layer and the portion to be protected.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a three-dimensional schematic view of a conventional protective sticker sheet adhered on a surface of a portion to be protected of a workpiece.

FIG. 1B is a three-dimensional schematic view of the workpiece after detaching the conventional protective sticker sheet.

FIG. 2 is a three-dimensional schematic view of a first aspect of a protective sticker sheet, according to one embodiment of the present invention.

FIG. 3 is a three-dimensional schematic view of a second aspect of the protective sticker sheet, according to one embodiment of the present invention.

FIG. 4 is a three-dimensional schematic view of the protective sticker sheet adhered on a surface of a portion to be protected of a workpiece, according to one embodiment of the present invention.

FIG. 5 is a three-dimensional schematic view of a first aspect of a protective sticker sheet, according to another embodiment of the present invention.

FIG. 6 is a three-dimensional schematic view of a second aspect of the protective sticker sheet, according to another embodiment of the present invention.

FIG. 7 is a three-dimensional schematic view of the protective sticker sheet adhered on a surface of a portion to be protected of a workpiece, according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

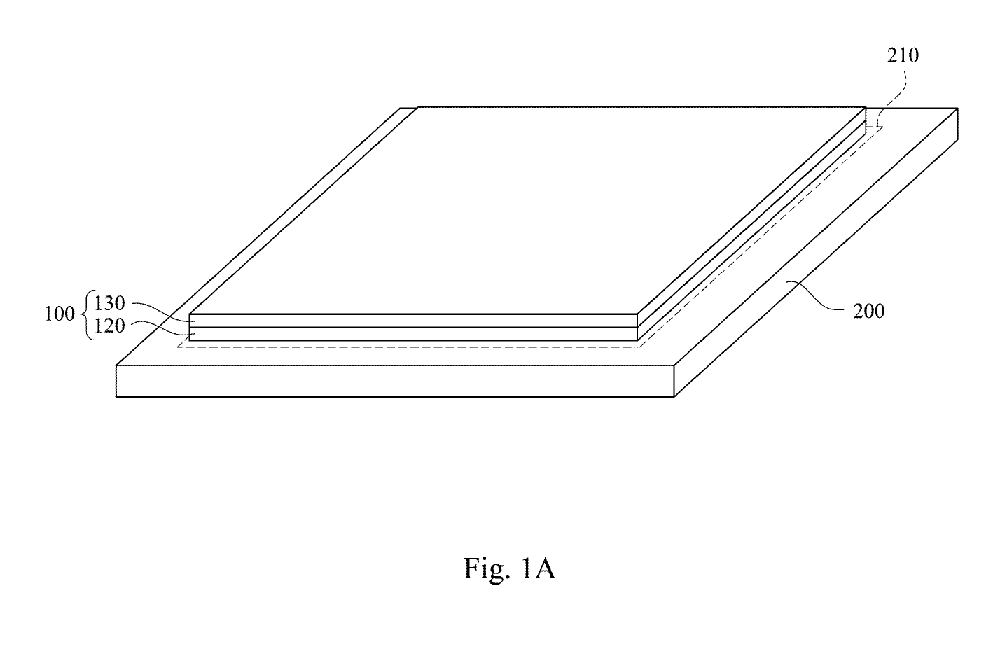

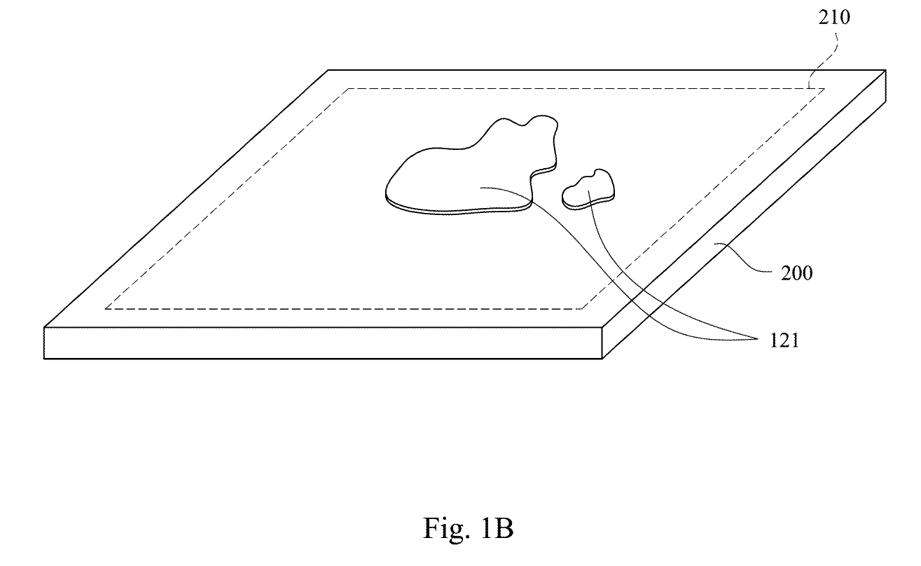

Please refer to FIG. 1A and FIG. 1B. FIG. 1A is a three-dimensional schematic view of a conventional protective sticker sheet adhered on a surface of a portion to be protected of a workpiece, while FIG. 1B is a three-dimensional schematic view of the workpiece after detaching the conventional protective sticker sheet. As shown in FIG. 1A, the workpiece 200 has a portion 210 to be protected. A protective sticker sheet 100 is adhered on a surface of the portion 210 to be protected. The protective sticker sheet 100 has a contour substantially the same as a contour of the portion 210 to be protected, and the protective sticker sheet 100 includes a protective film 130 and an adhesive layer 120. The protective film 130 is to prevent the portion 210 to be protected from being scratched or contaminated, while the adhesive layer 120 is to bond the protective film 130 with the workpiece 200. Accordingly, the portion 210 to be protected will not be damaged, contaminated or scratched when the workpiece 200 adhered with the protective sticker sheet 100 is colliding or rubbing with other objects. However, as described above, a portion of the adhesive layer 120 may transfer and remain on the surface of the portion 210 to be protected if the protective sticker sheet 100 has been adhered for a long time, or the workpiece 200 is put under higher ambient temperature. As shown in FIG. 1B, the surface of the portion 210 of the workpiece 200 has a residual adhesive 121 after detaching the protective sticker sheet 100. It is understood that the residual adhesive 121 may have a larger area depending on the duration of having the protective sticker sheet 100 adhered or the ambient temperature. The residual adhesive 121 may be contaminated by some contaminants (such as dust particles), thereby causing a dirty appearance of the portion 210 to be protected and even influencing the performance of the workpiece 200. For example, the workpiece 200 is a smartphone, while the portion 210 to be protected may be a screen or a camera of the smartphone. As the residual adhesive blemished by dust particles remains on the screen of a smartphone, some drawbacks may arise, such as poor appearance, poor displaying, poor touch screen sensitivity and else. On the other hand, the photo or video quality may be affected since the residual adhesive blemished by dust particles is present on the camera of the smartphone.

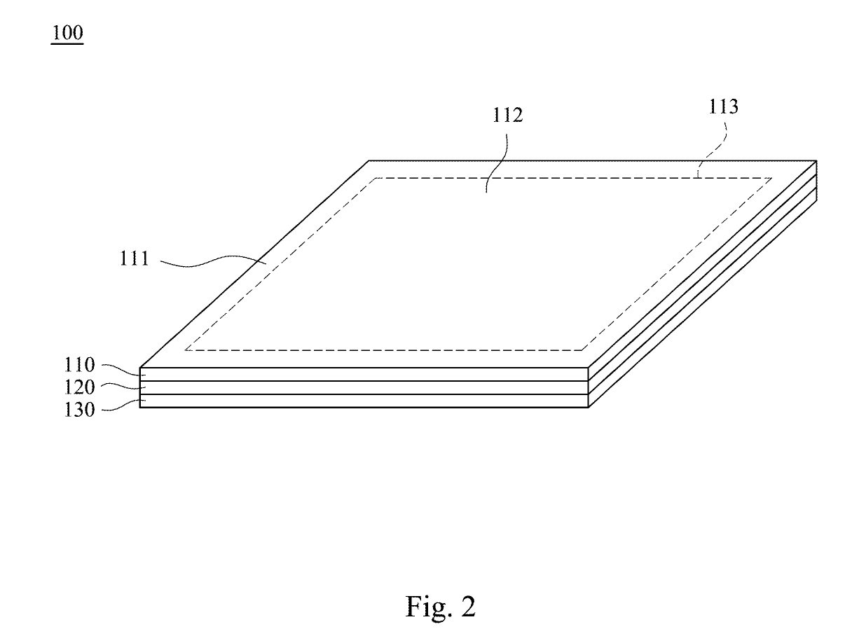

Please refer to FIG. 2. FIG. 2 is a three-dimensional schematic view of a first aspect of a protective sticker sheet 100 according to one embodiment of the present invention. As shown in FIG. 2, the protective sticker sheet 100 includes a protective film 130, an adhesive layer 120 disposed on the protective film 130, and a release film 110 disposed on the adhesive layer 120. The protective film 130, the adhesive layer 120 and the release film 110 has substantially similar contours. It is understood that, although the contours of the protective film 130, the adhesive layer 120 and the release film 110 depicted in FIG. 2 are quadrilateral, but are not limited thereto. Specifically, the contours of the protective film 130, the adhesive layer 120 and the release film 110 may correspond to a contour of the portion to be protected of the workpiece, which is to be protected. For instance, as the contour of the portion to be protected has a round shape, an elliptical shape, a triangular shape or a hexagonal shape, the contours of the protective film 130, the adhesive layer 120, and the release film 110 may be the corresponding round shape, elliptical shape, triangular shape or hexagonal shape. The release film 110 has a cutting line 113. The cutting line 113 defines a reserved portion 112 and a detachable removal portion 111. The removal portion 111 surrounds a periphery of the reserved portion 112. In practice, the cutting line 113 is a trench having a quite narrow width formed by a cutting process. In other words, the reserved portion 112 and the removal portion 111 has a gap in between, thus the reserved portion 112 is not affected and remains on the adhesive layer 120 during the detaching of the removal portion 111. Although the contour of the periphery of the reserved portion 112 is the same with the contours of the protective film 130, the adhesive layer 120 and the release film 110 in the embodiments depicted in FIG. 2 (all of them are quadrilateral), the shape of the periphery of the reserved portion 112 may have a slight variation in some other embodiments. For example, each of the four edges of the quadrilateral periphery of the reserved portion 112 as depicted in FIG. 2 may be a slightly curved line or an irregular line instead of a perfect straight line. In the meanwhile, each of the four corners of the quadrilateral periphery may be an acute angle or an obtuse angle instead of a right angle. In other words, even the periphery of the reserved portion 112, the protective film 130, the adhesive layer 120, and the release film 110 may have different contours, and this is still a technical solution that can be adopted by the present invention without departing from the scope of the invention.

In some embodiments, the protective film 130 includes a polyester resin, a polysulfone resin, a polyetherketone resin, or a polyolefin resin. The polyester resin may be such as polyethylene terephthalate (PET), polybutylene terephthalate (PBT), polyaromatic ester resins, or the like. The polysulfone resin may be such as polysulfone, polyethersulfone (PES), or the like. The polyetherketone resins may be such as polyetherketone (PEK), polyetheretherketone (PEEK) or the like. The polyolefin resin may be such as polyethylene, polypropylene, or the like. In some embodiments, the protective film 130 has a thickness of 25-75 micrometers, such as 30 micrometers, 40 micrometers, 50 micrometers, or 60 micrometers. If the thickness of the protective film 130 is less than 25 micrometers, it will be insufficient to prevent scratching and collision. However, if the thickness of the protective film 130 is greater than 75 micrometers, a higher manufacturing cost and an appearance which is not compact and fit to current products might arise.

In some embodiments, the adhesive layer 120 includes acrylic, polyurethane or silicone. In some embodiments, the adhesive layer 120 has a thickness of 5-25 micrometers, such as 10 micrometers, 15 micrometers, or 20 micrometers. If the thickness of the adhesive layer 120 is less than 5 micrometers, therefore the adhesive strength will be poor. However, if the thickness of the adhesive layer 120 is greater than 25 micrometers, the manufacturing cost will be increased without yet any increasing adhesive strength.

In some embodiments, the release film 110 includes a polyester resin, a polysulfone resin, a polyetherketone resin, or a polyolefin resin. The polyester resin may be such as polyethylene terephthalate (PET), polybutylene terephthalate, (PBT), polyaromatic ester resins, or the like. The polysulfone resin may be such as polysulfone, polyethersulfone (PES), or the like. The polyetherketone resin may be such as polyetherketone (PEK), polyetheretherketone (PEEK), or the like. The polyolefin resin may be such as polyethylene, polypropylene, or the like. In some embodiments, the release film 110 has a thickness of 25-75 micrometers, such as 30 micrometers, 40 micrometers, 50 micrometers, or 60 micrometers. If the thickness of the release film 110 is less than 25 micrometers, then the release film 110 will be fragile and prone to fragmentation when it is being detached. However, if the thickness of the release film 110 is greater than 75 micrometers, the manufacturing cost will be too high.

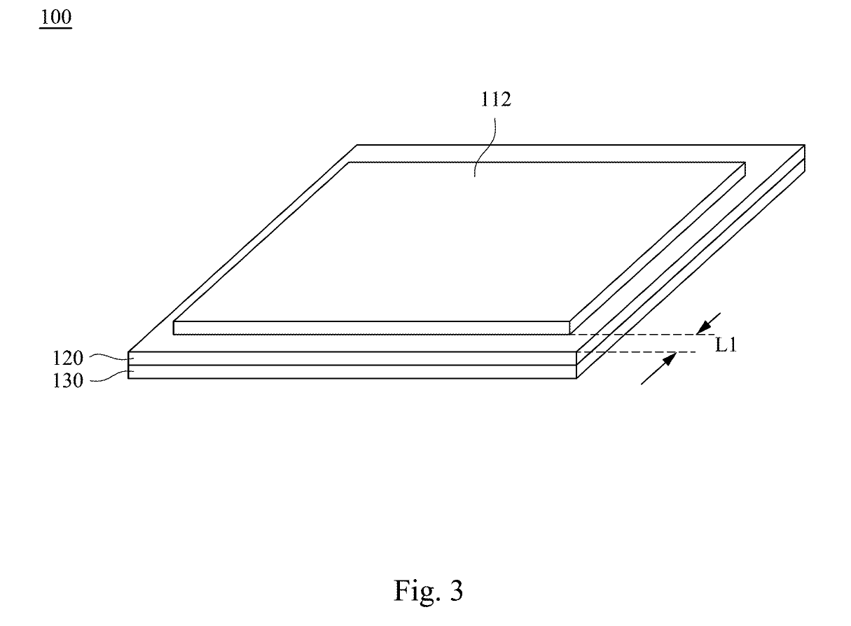

Please refer to FIG. 3. FIG. 3 is a three-dimensional schematic view of a second aspect of the protective sticker sheet 100, according to some embodiments of the present invention. As shown in FIG. 3, in the second aspect of the protective sticker sheet 100, the removal portion 111 of the release film 110 is detached, while the reserved portion 112 remains on the adhesive layer 120. Accordingly, the portion of the adhesive layer 120 that is under the removal portion 111 is exposed and therefore can be used to adhere the protective sticker sheet 100 onto the portion to be protected of the workpiece. A distance L1 is present between the periphery of the reserved portion 112 and the periphery of the adhesive layer 120 (or protective film 130) (that is, between the outer contour line and the inner contour line of the removal portion 111). It is understood that, the distance L1 is at least greater than 2 millimeters to provide a sufficient area for the exposed portion of the adhesive layer 120, thus the protective sticker sheet 100 may have good adhesion onto the portion to be protected without peeling off. However, the distance L1 has an upper limit value. Taking the protective sticker sheet 100 in FIG. 3 as an example, the edges of the quadrilateral periphery of the reserved portion 112 and the edges of the adhesive layer 120 (or the protective film 130) has four distances L1. As the values of these distances L1 are greater, the area of the reserved portion 112 is smaller. The protective sticker sheet 100 must possess the reserved portion 112 disposed on the adhesive layer 120 to gain a technical effect of the present invention. In other words, the upper limit value of the distance L1 is a value allowing the protective sticker sheet 100 to have a minimum area of the reserved portion 112. The specific technical effect is described in below.

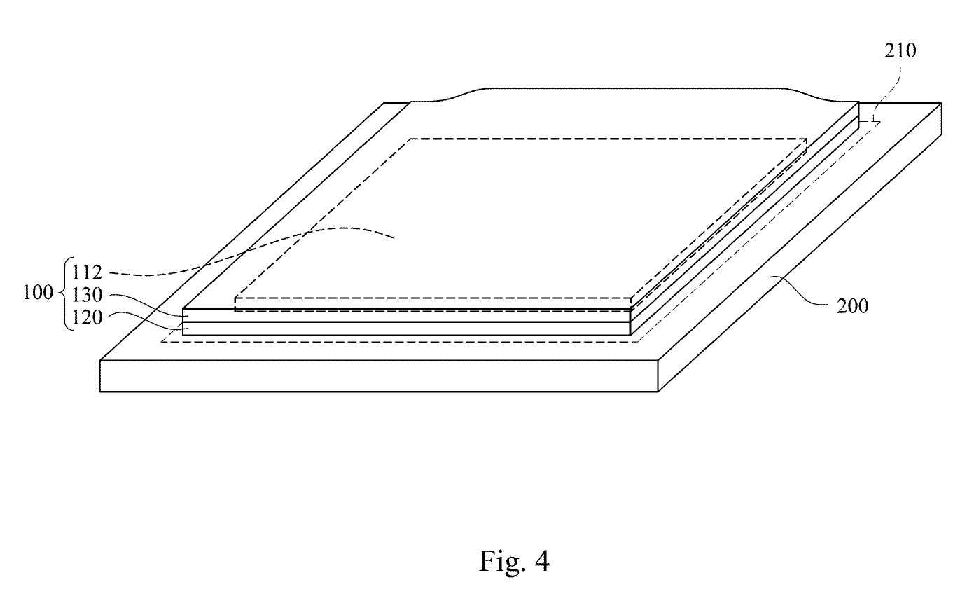

Please refer to FIG. 4. FIG. 4 is a three-dimensional schematic view of the protective sticker sheet 100 adhered on the surface of the portion 210 to be protected of the workpiece 200, according to one embodiment of the present invention. As shown in FIG. 4, the protective sticker sheet 100 (FIG. 3) with removal portion 111 removed is adhered onto the portion 210 of the workpiece 200 to be protected. The exposed portion of the adhesive layer 120 is adhered along the fours edges of the portion 210 to be protected, and the reserved portion 112 is covered by the adhesive layer 120. In other words, when the protective sticker sheet 100 is adhered onto the surface of the portion 210 to be protected, the reserved portion 112 is located between the adhesive layer 120 and the portion 210 to be protected, thus a portion of the adhesive layer 120 is not in direct contact with the portion 210 to be protected. As described above, a specific technical effect may be gained since the protective sticker sheet 100 having the reserved portion 112 is adhered onto the surface of the portion 210 to be protected. Specifically, the reserved portion 112 separates a portion of the adhesive layer 120 and the portion 210 to be protected, such that the adhesive layer 120 is unable to migrate onto the surface of the portion 210 to be protected during a lasting adhesion or under a high ambient temperature. In other words, a portion of the release film (reserved portion 112) is remained on the adhesive layer 120, thereby the migration and residual of the adhesive layer 120 on the surface of the portion 210 to be protected are eliminated.

It is noted that, as described above, the contour of the portion 210 to be protected is not limited to be the quadrilateral depicted in FIG. 4, it may be a round shape, an elliptical shape, a triangular shape or a hexagonal shape, or the like. The contour of the protective sticker sheet 100 (protective film 130, adhesive layer 120, and the reserved portion 112 of the release film 110) may be the corresponding round shape, elliptical shape, triangular shape or hexagonal shape. For example, when the contour of the portion 210 to be protected is a round shape, the contours of the protective film 130, adhesive layer 120, and the reserved portion 112 of the release film 110 are the corresponding round shape, and the round exposed portion of the adhesive layer 120 is adhered along the round edge of the portion 210 to be protected, while the round reserved portion 112 is covered by the adhesive layer 120.

A pasting method of the protective sticker sheet 100 is provided herein as well. The method includes the following steps. Please refer to FIG. 2 together with FIG. 3 and FIG. 4. At first, a workpiece 200 is provided, and the workpiece 200 has a portion 210 to be protected. Next, a protective sticker sheet 100 is provided. The protective sticker sheet 100 includes a protective film 130, an adhesive layer 120 disposed on the protective film 130, and a release film 110 disposed on the adhesive layer 120. The release film 110 has a cutting line 113, and the cutting line 113 defines a reserved portion 112 and a detachable removal portion 111. The removal portion 111 surrounds a portion of the reserved portion 112. Subsequently, the removal portion 111 of the protective sticker sheet 100 is removed to form an adherable protective sticker. The reserved portion 112 is remained on the adhesive layer 120, and a portion of the adhesive layer 120 is exposed. Lastly, the adherable protective sticker is adhered on the portion 210 to be protected of the workpiece 200. The reserved portion 112 is located between the adhesive layer 120 and the portion 210 to be protected.

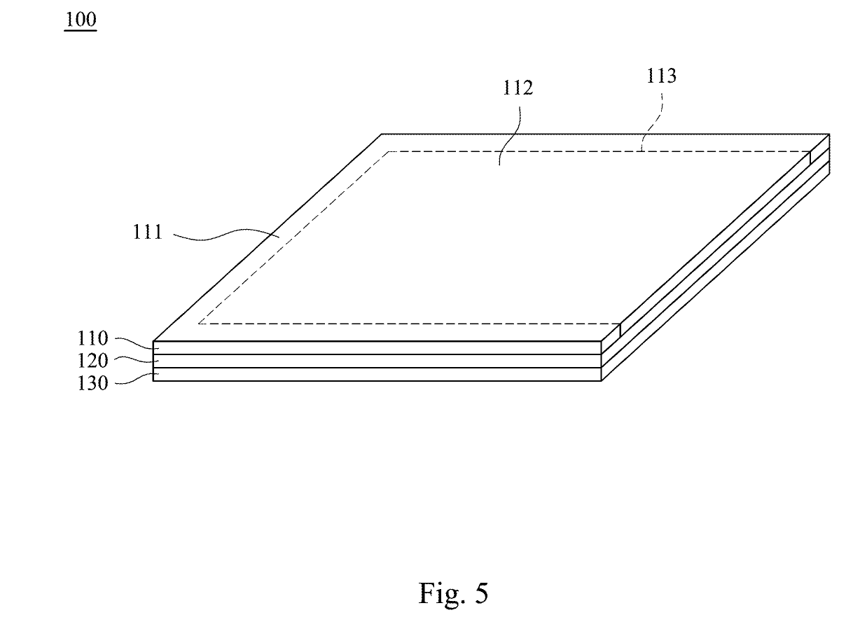

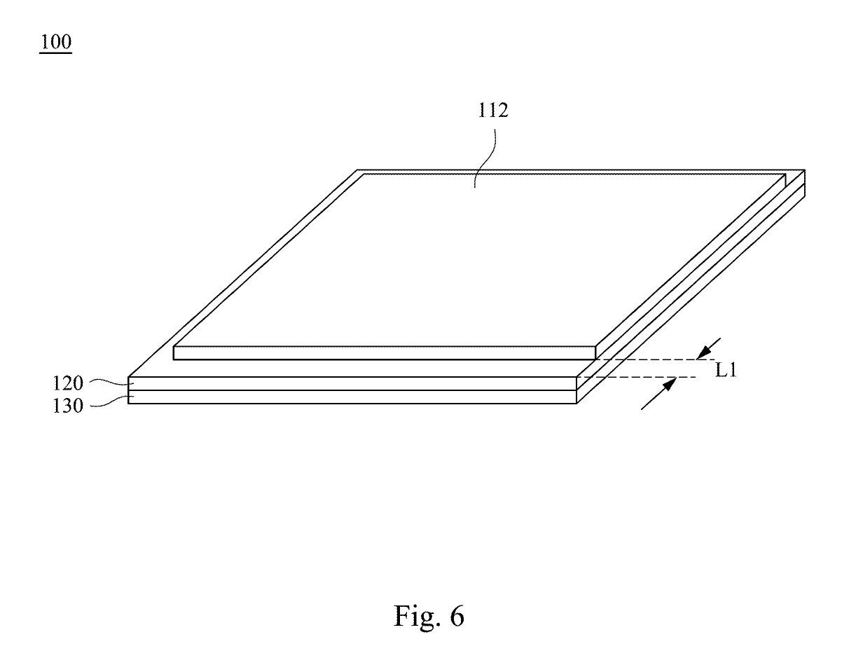

Please refer to FIG. 5. FIG. 5 is a three-dimensional schematic view of a second aspect of the protective sticker sheet 100, according to another embodiment of the present invention. The protective sticker sheet 100 of FIG. 5 is similar to that of the FIG. 2 and differs in that the cutting line 113 of the protective sticker sheet 100 in FIG. 5 is corresponding to the three edges of the quadrilateral periphery of the release film 110. In other words, the detachable removal portion 111 defined by the cutting line 113 surrounds three edges of the periphery of the reserved portion 112. Please refer to FIG. 6. FIG. 6 is a three-dimensional schematic view of the protective sticker sheet 10, according to another embodiment of the present invention. As shown in FIG. 6, the removal portion 111 of the release film 110 is detached, while the reserved portion 112 remains on the adhesive layer 120. Accordingly, a portion of the adhesive layer 120 under the removal portion 111 is exposed and therefore can be used to adhere the protective sticker sheet 100 onto the portion of the workpiece to be protected. A distance L1 is arranged between the three edges of the periphery of the reserved portion 112 and the corresponding three edges of the periphery of the adhesive layer 120 (or protective film 130) (that is, between the outer contour line and the inner contour line of the removal portion 111). The limitations of the distance L1 are described above, and therefore are not repeated herein. It is understood that, the removal portion 111 must surrounds at least third-quarters of the periphery of the reserved portion 112 to provide a good adhesion between the protective sticker sheet 100 and the portion to be protected without peeling off. Accordingly, the exposed portion of the adhesive layer 120 has enough area to provide a good adhesion between the protective sticker sheet 100 and the portion to be protected without peeling off after detaching the removal portion 111.

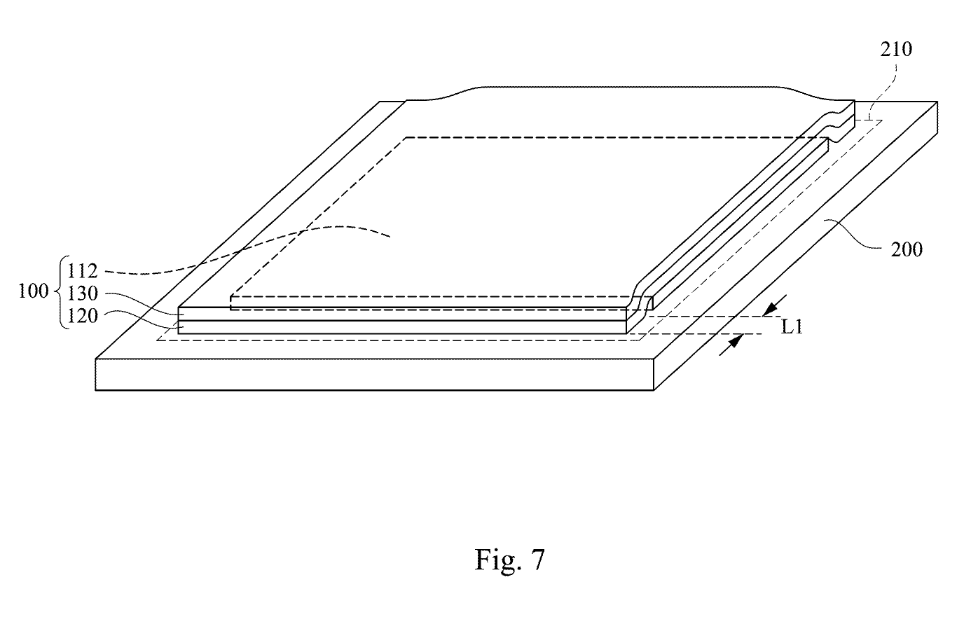

Please refer to FIG. 7. FIG. 7 is a three-dimensional schematic view of the protective sticker sheet 100 adhered on a surface of the portion 210 to be protected of the workpiece 200, according to another embodiment of the present invention. As shown in FIG. 7, the protective sticker sheet 100 (FIG. 6) is adhered on the portion 210 to be protected of the workpiece 200 as the removal portion 111 is detached. The exposed portion of the adhesive layer 120 is adhered along the three edges of the portion 210 to be protected. The adhesive layer 120 covers the reserved portion 112, and a side edge of the reserved portion 112 is exposed. In other words, when the protective sticker sheet 100 is adhered onto the surface of the portion 210 to be protected, the reserved portion 112 is located between the adhesive layer 120 and the portion 210 to be protected, thereby a portion of the the adhesive layer 120 may not in direct contact with the portion 210 to be protected. Therefore, the migration and the residual of the adhesive layer 120 on the surface of the portion 210 to be protected are eliminated.

It is understood that, although the protective sticker sheet 100 has a tri-layered structure (protective film 130, adhesive layer 120, and release film 110) in the embodiments of FIG. 2 or FIG. 5, the protective sticker sheet 100 may further include other layers in yet some other embodiments. For example, an anti-blue light layer, an anti-reflection layer, or an anti-glare layer and else may be disposed between the protective film 130 and the adhesive layer 120, or may be disposed on the protective film 130.

As described in the embodiments above, the release film of the protective sticker sheet as disclosed herein has a reserved portion and a detachable removal portion, therefore the reserved portion is located between the adhesive layer and the workpiece when the protective sticker sheet is adhered on the workpiece. Accordingly, a portion of the adhesive layer and the workpiece are not in direct contact, the migration and residual of the adhesive layer on the workpiece are eliminated. In addition, those skilled in the art may readily cut out the protective sticker sheet along the contour of the portion to be protected of the workpiece, thereby the contour of the protective sticker sheet as disclosed herein may correspond to the contour of the portion to be protected.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A protective sticker sheet, comprising
a protective film;
an adhesive layer disposed on the protective film; and
a release film disposed on the adhesive layer, wherein the release film has a cutting line, the cutting line defines a reserved portion and a detachable removal portion of the release film, and the removal portion surrounds at least a portion of the reserved portion.

2. The protective sticker sheet of claim 1, wherein the removal portion surrounds at least three-quarters of a periphery of the reserved portion.

3. The protective sticker sheet of claim 1, wherein the removal portion has an outer contour line and an inner contour line, and a distance between the outer contour line and the inner contour line is greater than 2 millimeters.

4. The protective sticker sheet of claim 1, wherein the protective film includes a polyester resin, a polysulfone resin, a polyetherketone resin, or a polyolefin resin.

5. The protective sticker sheet of claim 1, wherein the release film includes a polyester resin, a polysulfone resin, a polyetherketone resin, or a polyolefin resin.

6. The protective sticker sheet of claim 1, wherein the adhesive layer includes acrylic, polyurethane, or silicone.

7. The protective sticker sheet of claim 1, wherein the protective film has a thickness of 25 to 75 micrometers.

8. The protective sticker sheet of claim 1, wherein the release film has a thickness of 25 to 75 micrometers.

9. The protective sticker sheet of claim 1, wherein the adhesive layer has a thickness of 5-25 micrometers.

10. A method of pasting a protective sticker sheet, comprising the steps of:
providing a workpiece having a portion to be protected;
providing a protective sticker sheet, the protective sticker sheet including a protective film, an adhesive layer disposed on the protective film, and a release film disposed on the adhesive layer, wherein the release film has a cutting line, the cutting line defines a reserved portion and a detachable removal portion of the release film, and the detachable removal portion surrounds at least a portion of the reserved portion;
removing the detachable removal portion of the protective sticker sheet to form an adherable protective sticker, wherein the reserved portion is remained on the adhesive layer, and a portion of the adhesive layer is exposed; and
adhering the adherable protective sticker on the portion to be protected of the workpiece, wherein the reserved portion is located between the adhesive layer and the portion to be protected.
